(19) United States
(12) Patent Application Publication
(10) Pub. No.: US 2008/0289456 A1
(43) Pub. Date: Nov. 27, 2008

(54) Right angle arm driven open end wrench

(76) Inventor: Kenneth Eugene Jensen, Sonoma, CA (US)

Correspondence Address: KENNETH E. JENSEN, 607 SIESTA WAY, SONOMA, CA, 95476, US

(21) Appl. No.: 11/804,984

(22) Filed: May 22, 2007

(51) Int. Cl. B25B 13/06

(52) U.S. Cl. 81/124.2

(57) ABSTRACT

The one solid wrench has a flat surface with jaws encompassed within a thin body with a right angle arm attached to the fop side opposite of the open jaw. The top of the arm has a square opening to receive a ratchet extension tool to drive the wrench. The tool is used as an open wrench having a thin wall that requires minimal clearance for 360 degree turning radius without the removal of any connecting lines.

### CROSS-REFERENCE TO RELATED APPLICATIONS

In reference to each prior application assigned U.S. Pat. No. D376,521 issued to Farnan on Dec. 17, 1996 the design is not a precession for close tolerance. The extension tap protrudes out constricting a small clearance radius. U.S. Pat. No. 5,050,463 issued to Stielow on Sep. 24, 1991 and U.S. Pat. No. 7,140,275 issued to Staples on Nov. 28, 2006 and U.S. Pub. App. No. 20070044593 issued to Murdoch on Mar. 1, 2007 and U.S. Pat. No. 6,339,978 issued to Hirse all are not precession instruments with design to allow for minimal clearance in small deep spaces.

An open end wrench comprising of a arm extending above the wrench allowing minimal clearance around a fastener having a plurality of sides. The open end wrench has a precession size and allows the wrench to access a fastener without the removal of an attached hose, pipe, or cable. The wrench body is small, narrow, and thin having the jaw opening on one side and the driving arm on top of the wrench side adjacent to it. The top of the driving arm has an opening to receive a conventional standard extension ratchet or T handle. The wrench jaws encircle the nut with precession to keep from stripping the comers. The tips of the jaws have a slight angle hook as to extend jaws for added stability.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The invention relates to a wrench which could be used as a socket with an opening so as to attach to a bolt or nut without the removal of an attached line or cable. The arm is connected on top of the far side of the opening on wrench so as not to obstruct the engaging hole around a nut. My experience as a plumber I have used various tools to install and remove connecting nuts and supply lines at awkward angles. The present invention gives a precession fit and correct angles with the unique and narrow design with the driving arm away from the deck and allowing for more turning radius. The arm allows for greater torque and management control of the tool.

### BRIEF SUMMARY OF THE INVENTION

The right angle open end wrench has an unique arm attached to the top opposite side of the wrench allowing for complete turning radius in a small confined obstructed space. Where other existing tools are cumbersome, awkward and at a wrong angle.

The wrench is used by slipping the open end on, or over a supply line, connecting pipe or cable connected to the nut. The sizes of the wrenches are precession sizes to eliminate stripping corners of the nut. The wrench is one solid piece and would be relatively easy to manufacture having no movable parts.

### BRIEF DESCRIPTION OF DRAWING

FIG. 1 is the top view showing the thin full turning radius capability and the tip hook (A).

FIG. 2 is the side view showing the drive arm and its elevation above the wrench with a thin body (B) rising to the opening for the extension bar.

FIG. 3 is the 3 dimensional angle showing the arm in relation to the wrench and the tips (A) with a slight angle hook for added stability.

FIG. 4 is the front of the wrench showing the relationship of the drive arm and wrench and thin body (B).

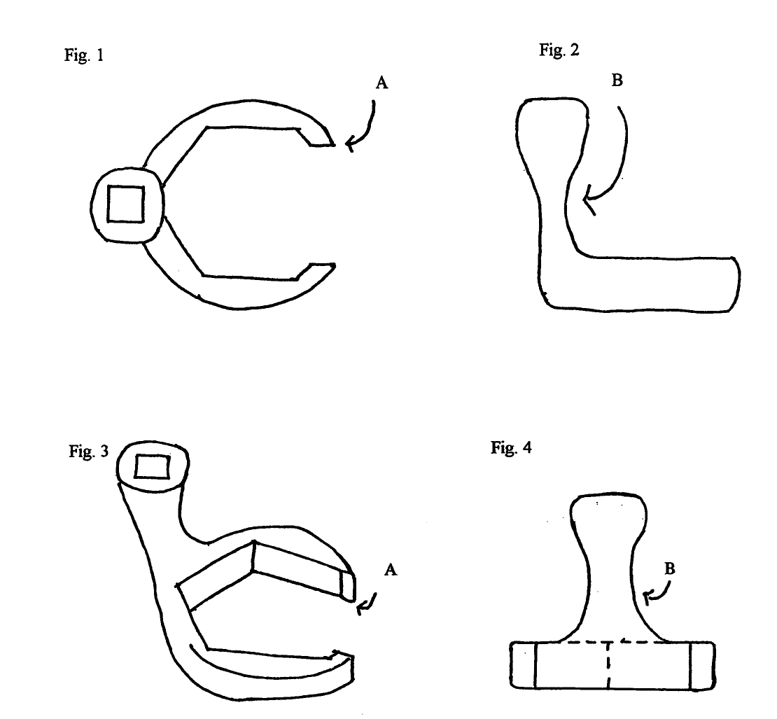

### DETAILED DESCRIPTION OF THE INVENTION

This present invention must be made of solid material as any open end wrench with shinny chrome. The invention has 2 jaws to fit a hexagon nut with precession size with a small hook at end of jaw opening for added stability on said nut. This new and unique wrench arm protrudes from the opposite adjacent side of the jaws and is up and away to prevent any obstruction of the turning radius unlike other wrenches (referred to in related applications on page 1) concerning clearance in small spaces.

The invention has been illustrated and described in detail in the drawings and foregoing description as illustrative and not restricted to limitations and all changes or modifications that come with the invention are desired to be protected.

What is claimed:

1. The driving arm is at a right angle which is unique and different and positioned on top of the wrench opposite of the open jaw. At the top of the arm is an opening to receive a conventional adapter to receive a ratchet extension or T handle. The open end wrench is used for the installation and removal of a hexagon nut in a limited, confined space, at a right angle position relating to the work piece.

2. The driving arm is 1″ for small wrenches to 2″ or more for larger wrenches in length. The driving arm is up and away from obstructing the turning radius. The thickness of the wrench body has the same thickness 360 degrees around and is minimal in relation to size of wrench also used as a socket.

3. The open part of the wrench is to allow the tool to surround a nut without having to remove a water line, pipe, or cable.
